(19) United States
(12) Patent Application Publication
(10) Pub. No.: US 2020/0173861 A1
(43) Pub. Date: Jun. 4, 2020

(54) Multi-Point Temperature Sensor Device

(71) Applicants: Chen-Chien Hsu, Taoyuan City (TW); Cheng-Te Hsu, Taoyuan City (TW)

(72) Inventors: Chen-Chien Hsu, Taoyuan City (TW); Cheng-Te Hsu, Taoyuan City (TW)

(21) Appl. No.: 16/680,697

(22) Filed: Nov. 12, 2019

(30) Foreign Application Priority Data
Nov. 30, 2018 (TW) 107142869

(51) Int. Cl. G01K 3/14; G01K 1/08; G01K 13/00

(52) U.S. Cl. CPC G01K 3/14; G01K 13/00; G01K 1/08

(57) ABSTRACT

A multi-point temperature sensor device include a body unit (1) and a sensor unit (2) mounted in the body unit (1). The sensor unit (2) includes a plurality of signal transmission lines (21; 21′) and a common wire (24) placed in parallel relation to the plurality of signal transmission lines (21; 21′). Each of the plurality of signal transmission lines (21; 21′) has an end to which a sensor (22) is mounted. The ends of the plurality of signal transmission lines (21; 21′) are spaced from each other in a longitudinal direction. The sensors (22) are electrically connected to the plurality of signal transmission lines (21; 21′) and the common wire (24).

### BACKGROUND OF THE INVENTION

The present invention relates to a multi-point temperature sensor device and, more particularly, to a multi-point temperature sensor device including a plurality of sensors in parallel relation to a common wire to reduce the volume and to permit easy manufacture.

Temperature sensors generally include a sensor mounted in a body and use a coaxial cable to transmit the temperature or humidity detected by the sensor. In an example shown in FIG. 13, metal wires B1 on two sides of a sensor B are riveted to a conductive wire A1 and a metal mesh A3 of a coaxial cable A by a conductive terminal D and a copper terminal B2, respectively. Furthermore, the sensor B is located outside of an inner insulating layer A2 and is isolated by an insulating sleeve E to prevent the metal wires B1 from becoming a short circuit which causes failure of the sensor B. Thus, in assembly, the temperature sensor must include the conductive terminal D, the copper terminal B2, and the insulating sleeve E which increase the material costs.

Furthermore, in assembly of the temperature detector, the metal mesh A3 must be firstly retracted rearwards or stretched before riveting the conductive terminal D to cover the metal wires B1 of the sensor B and the conductive wire A1 of the coaxial cable A, and the insulating sleeve E is then mounted. Next, the metal mesh A3 restores its original shape. Then, an end of the metal mesh A3 and the metal wire B1 are clamped by the copper terminal B2. A metal housing C can be then assembled. The assembling procedures are complicated and increase the labor costs.

In a case that plural sensors B are required in the metal housing C to allow the temperature detector to conduct detection at plural locations, plural coaxial cables A are used to connect with the plural sensors B, respectively, leading to complicated manufacture and assembly, requirement of significant labor and material costs, and a bulky size.

Thus, a need exists for a novel temperature sensor that mitigates and/or obviates the above disadvantages.

### BRIEF SUMMARY OF THE INVENTION

The primary objective of the present invention is to provide a multi-point temperature sensor device comprising a sensor unit having a plurality of signal transmission lines arranged in a longitudinal direction. Each of the plurality of signal transmission lines has an end to which a sensor is mounted. A common line is electrically connected to the sensors. Thus, the sensor unit has a significantly reduced volume and can be manufactured conveniently.

To achieve the above objective, the present invention provides a multi-point temperature sensor device comprising a body unit and a sensor unit mounted in the body unit. The sensor unit includes a plurality of signal transmission lines and a common wire placed in parallel relation to the plurality of signal transmission lines. Each of the plurality of signal transmission lines has an end to which a sensor is mounted. The ends of the plurality of signal transmission lines are spaced from each other in a longitudinal direction. The sensors are electrically connected to the plurality of signal transmission lines and the common wire.

In an example, each of the plurality of signal transmission lines includes a conductor and an insulating sheath covering an outer periphery of the conductor. Each sensor includes a sensing portion and first and second connecting portions on two sides of the sensing portion. The first connecting portion is disposed in the insulating sheath and is electrically connected to the conductor. The second connecting portion is bent and abuts an outer side of the insulating sheath.

In an example, the second connecting portion is connected to the common wire by welding.

In another example, the sensor unit further includes a plurality of terminals made of an electrically conductive material. Each sensor is bonded to an associated one of the plurality of signal transmission lines and the common wire by one of the plurality of terminals, such that each sensor is electrically connected to the common wire. Each of the plurality of terminals bonds the second connecting portion of an associated sensor and the common wire to an outer side of the insulating sheath.

In a further example, the common wire includes a plurality of contact portions that is annular, and the second connecting portion of each sensor extends through an associated one of the plurality of contact portions to thereby electrically connect to the common wire.

In still another example, the second connecting portion of each sensor includes a contact portion that is annular, and the common wire extends through and is electrically connected to the second connecting portions of the sensors.

The present invention will become clearer in light of the following detailed description of illustrative embodiments of this invention described in connection with the drawings.

### DESCRIPTION OF THE DRAWINGS

FIG. 1 is a partial, cross sectional view of a multi-point temperature sensor device of an embodiment according to the present invention.

FIG. 2 is an exploded, cross sectional view illustrating a signal transmission line and a sensor of the multi-point temperature sensor device of FIG. 1.

FIG. 3 is a cross sectional view of the signal transmission line and the sensor of FIG. 2.

FIG. 4 is a view similar to FIG. 3 with a second connecting section of the sensor bent.

FIG. 5 is a view similar to FIG. 4 with a common wire welded to the sensor.

FIG. 6 is a diagrammatic side view illustrating a plurality of sensors welded to a common wire.

FIG. 7 is a diagrammatic view illustrating bonding of a sensor and a common wire.

FIG. 8 is a diagrammatic side view illustrating bonding of a plurality sensors and a common wire.

FIG. 9 is a diagrammatic view illustrating electrical connection between second connecting portions of a plurality of sensors and contact portions of a common wire.

FIG. 10 is a diagrammatic view illustrating a common wire extending through and in contact with contact portions of a plurality of sensors.

FIG. 11 is a diagrammatic view illustrating use of the multi-point temperature sensor device.

FIG. 12 is a partial, cross sectional view of a multi-point temperature sensor device of another embodiment according to the present invention.

FIG. 13 is a partial, cross sectional view of a conventional temperature sensor.

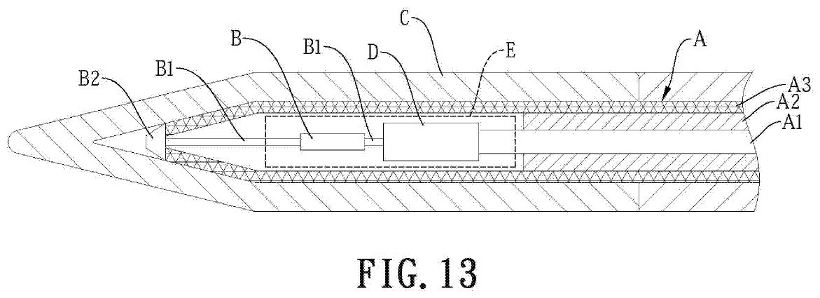

### DETAILED DESCRIPTION OF THE INVENTION

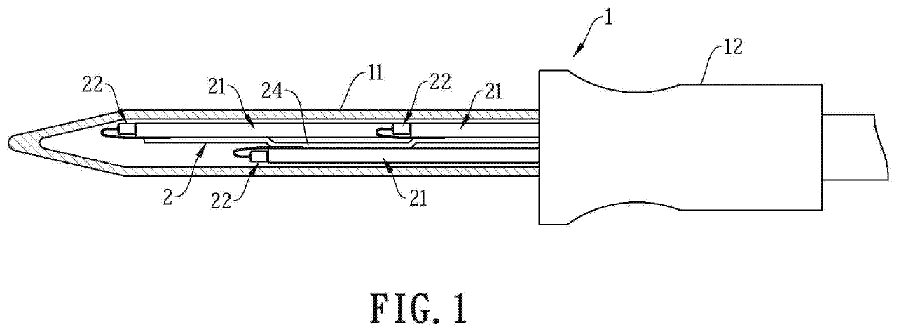

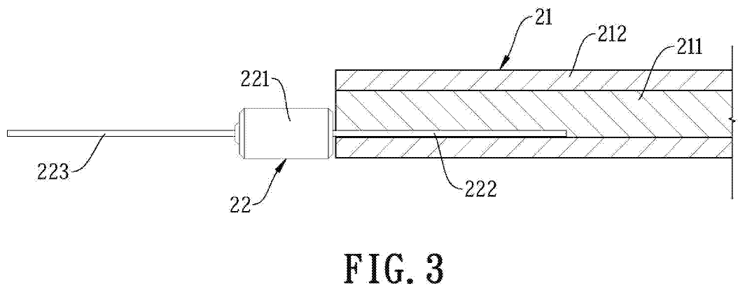

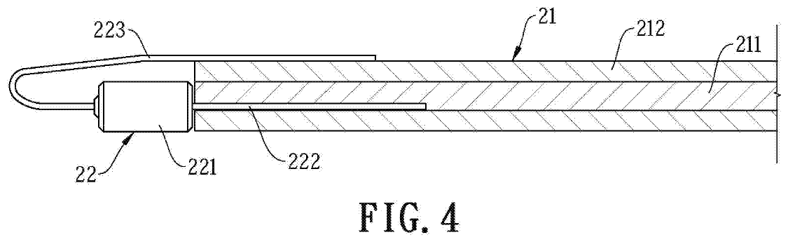

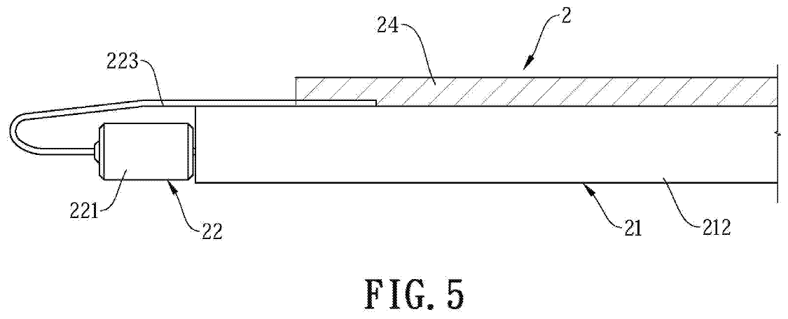

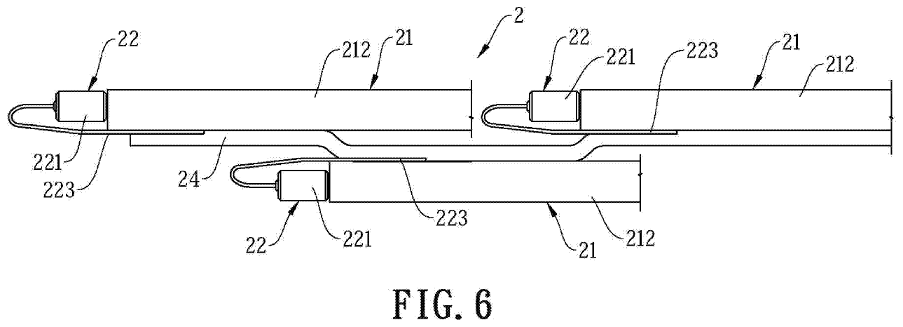

With reference to FIGS. 1-6, a multi-point temperature sensor device of an embodiment according to the present invention comprises a body unit 1 and a sensor unit 2 mounted in the body unit 1. The body unit 1 includes a housing 11 in the form of a metal tube and a handle 12 mounted to an end of the housing 11.

The sensor unit 2 includes a plurality of signal transmission lines 21, a plurality of sensors 22, and a common wire 24. Each of the plurality of signal transmission lines 21 includes a body 211 and an insulating sheath 212 covering an outer periphery of the conductor 211. Each sensor 22 includes a sensing portion 221 and first and second connecting portions 222 and 223 on two sides of the sensing portion 221. In this embodiment, the body 211 is in the form of a single core wire, and the common wire 24 is a bare metal wire.

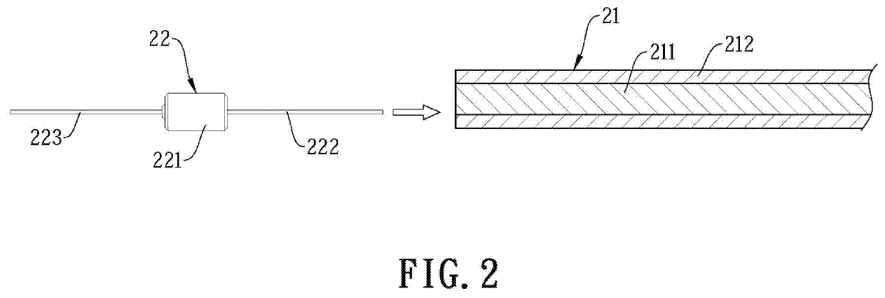

With reference to FIGS. 2-4, in assembly, the first connecting portion 222 of each sensor 22 is inserted from an end of an associated one of the plurality of signal transmission lines 21 into the insulating sheath 212 to be in electrical connection with the conductor 211 through contact. Then, the second connecting portion 223 is bent towards the associated signal transmission line 21 to abut an outer side of the insulating sheath 212. The above procedures are repeated until all sensors 22 and the plurality of signal transmission lines 21 are assembled.

With reference to FIGS. 1, 5, and 6, the common wire 24 and the plurality of signal transmission lines 21 are placed in parallel relation. The ends of the plurality of signal transmission lines 21 are spaced from each other in a longitudinal direction. The second connecting portion 223 of each sensor 22 is securely and electrically connected to the common wire 24 by welding. Thus, the sensor unit 2 is assembled and then placed into the housing 11.

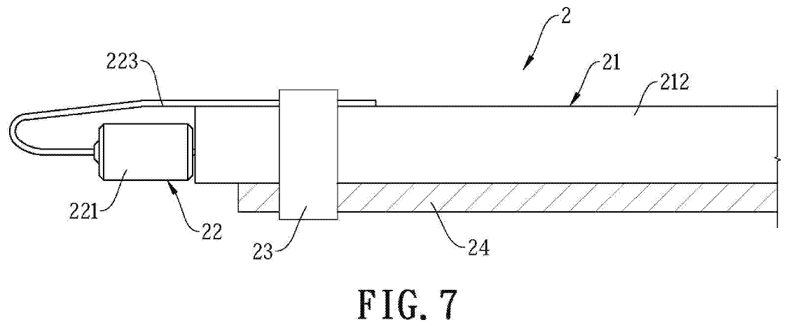

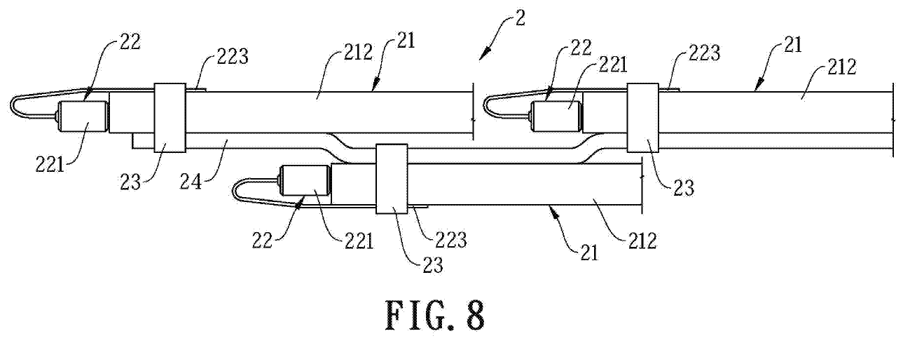

With reference to FIGS. 7 and 8, the difference between this embodiment and the above embodiment is that the sensor unit 2 further includes a plurality of terminals 23 made of an electrically conductive material, such as metal. The common wire 24 and the plurality of signal transmission lines 21 are placed in parallel relation. The ends of the plurality of signal transmission lines 21 are spaced from each other in a longitudinal direction. Each sensor 22 and the common wire 24 are bonded to the outer side of the insulating sheath 212 of an associated one of the plurality of signal transmission lines 21 by one of the plurality of terminals 23. Since the plurality of terminals 23 is made of a metal material, even if the common wire 24 is not in contact with the second connecting portions 223, the common wire 24 will be electrically connected to the second connecting portions 223 through the plurality of terminals 23. Furthermore, the sensors 22 are securely connected to the plurality of signal transmission lines 21 by bonding the second connecting portions 223 of the sensors 22 to the outer side of the insulating sheath 212 through use of the plurality of terminals 23.

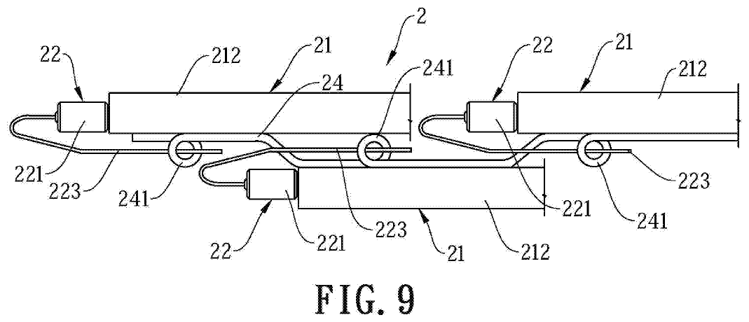

With reference to FIG. 9, the difference between this embodiment and the above embodiments is that the common wire 24 includes a plurality of contact portions 241 that is annular. The second connecting portion 223 of each sensor 22 extends through an associated one of the plurality of contact portions 241 to thereby electrically connect to the common wire 24.

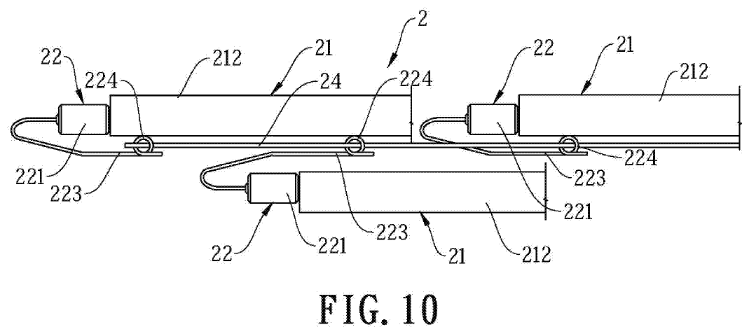

With reference to FIG. 10, the difference between this embodiment and the above embodiments is that the second connecting portion 223 of each sensor 22 includes a contact portion 224 that is annular. The common wire 24 extends through and is electrically connected to the second connecting portions 223 of the sensors 22.

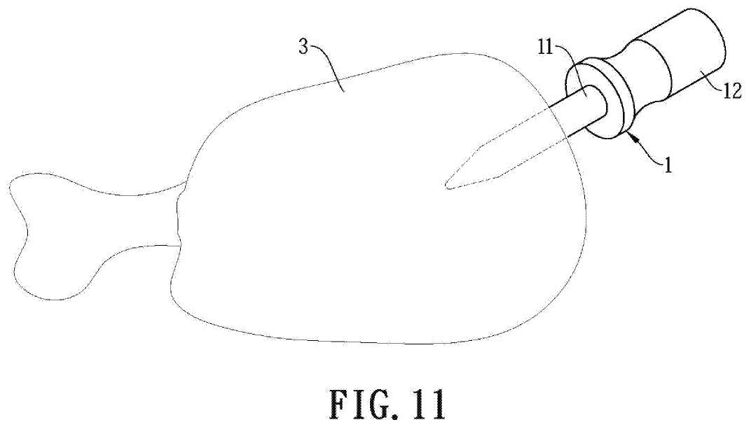

With reference to FIGS. 1 and 11, in use, a user holds the handle 12 of the body unit 1 and inserts the housing 11 into food 3 whose temperature is to be detected. Since the sensors 22 placed in different locations in the longitudinal direction can sense the temperatures at different depths of the food 3. The temperature signals are transmitted to a host machine (not shown) connected to the plurality of signal transmission lines 21. The temperatures are displayed by the host machine, such that the user can judge whether the food 3 has been thoroughly heated or has been heated to the predetermined temperature.

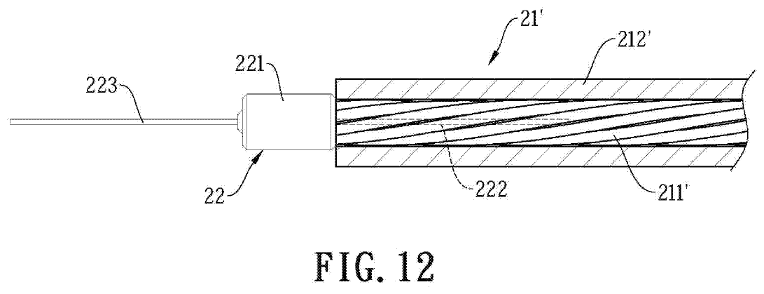

With reference to FIG. 12, the conductor 211′ of each of the plurality of signal transmission lines 21′ can be a stranded wire and is covered by an insulating sheath 212′.

Although specific embodiments have been illustrated and described, numerous modifications and variations are still possible without departing from the scope of the invention. The scope of the invention is limited by the accompanying claims.

1. A multi-point temperature sensor device comprising a body unit and a sensor unit mounted in the body unit, characterized in that:
the sensor unit includes a plurality of signal transmission lines and a common wire placed in parallel relation to the plurality of signal transmission lines, wherein each of the plurality of signal transmission lines has an end to which a sensor is mounted, wherein the ends of the plurality of signal transmission lines are spaced from each other in a longitudinal direction, and wherein the sensors are electrically connected to the plurality of signal transmission lines and the common wire.

2. The multi-point temperature sensor device as claimed in claim 1, wherein each of the plurality of signal transmission lines includes a conductor and an insulating sheath covering an outer periphery of the conductor, wherein each sensor includes a sensing portion and first and second connecting portions on two sides of the sensing portion, wherein the first connecting portion is disposed in the insulating sheath and is electrically connected to the conductor, wherein the second connecting portion is bent and abuts an outer side of the insulating sheath, and wherein the second connecting portion is connected to the common wire by welding.

3. The multi-point temperature sensor device as claimed in claim 1, wherein the sensor unit further includes a plurality of terminals made of an electrically conductive material, wherein each sensor is bonded to an associated one of the plurality of signal transmission lines and the common wire by one of the plurality of terminals, such that each sensor is electrically connected to the common wire.

4. The multi-point temperature sensor device as claimed in claim 3, wherein each of the plurality of signal transmission lines includes a conductor and an insulating sheath covering an outer periphery of the conductor, wherein each sensor includes a sensing portion and first and second connecting portions on two sides of the sensing portion, wherein the first connecting portion is disposed in the insulating sheath and is electrically connected to the conductor, wherein the second connecting portion is bent and abuts an outer side of the insulating sheath, and wherein each of the plurality of terminals bonds the second connecting portion of an associated sensor and the common wire to an outer side of the insulating sheath.

5. The multi-point temperature sensor device as claimed in claim 1, wherein each of the plurality of signal transmission lines includes a conductor and an insulating sheath covering an outer periphery of the conductor, wherein each sensor includes a sensing portion and first and second connecting portions on two sides of the sensing portion, wherein the first connecting portion is disposed in the insulating sheath and is electrically connected to the conductor, wherein the second connecting portion is bent and abuts an outer side of the insulating sheath, wherein the common wire includes a plurality of contact portions that is annular, wherein the second connecting portion of each sensor extends through an associated one of the plurality of contact portions to thereby electrically connect to the common wire.

6. The multi-point temperature sensor device as claimed in claim 1, wherein each of the plurality of signal transmission lines includes a conductor and an insulating sheath covering an outer periphery of the conductor, wherein each sensor includes a sensing portion and first and second connecting portions on two sides of the sensing portion, wherein the first connecting portion is disposed in the insulating sheath and is electrically connected to the conductor, wherein the second connecting portion is bent and abuts an outer side of the insulating sheath, wherein the second connecting portion of each sensor includes a contact portion that is annular, wherein the common wire extends through and is electrically connected to the second connecting portions of the sensors.
